(19) United States
(12) Patent Application Publication
(10) Pub. No.: US 2018/0241781 A1
(43) Pub. Date: Aug. 23, 2018

(54) SECURITY RULES INCLUDING PATTERN MATCHING FOR IOT DEVICES

(71) Applicant: Microsoft Technology Licensing, LLC, Redmond, WA (US)

(72) Inventor: Clemens Vasters, Viersen (DE)

(21) Appl. No.: 15/436,107

(22) Filed: Feb. 17, 2017

(51) Int. Cl. H04L 29/06; G06N 99/00

(52) U.S. Cl. CPC H04L 63/205; G06N 99/005; H04L 63/123

(57) ABSTRACT

The disclosed technology is generally directed to device security in an IoT environment. In one example of the technology, a set of security rules is stored. The set of security rules includes a set of reference signals. Telemetry data is received over time from an external device. A determination is made, based on the received telemetry data, as to whether the set of security rules has been violated. The determination includes behavioral pattern matching between the received telemetry data and at least one reference signal of the set of reference signals. The received telemetry data is selectively authorized as valid based on the determination.

### BACKGROUND

The Internet of Things (“IoT”) generally refers to a system of devices capable of communicating over a network. The devices can include everyday objects such as toasters, coffee machines, thermostat systems, washers, dryers, lamps, automobiles, and the like. The network communications can be used for device automation, data capture, providing alerts, personalization of settings, and numerous other applications.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to device security in an IoT environment. In one example of the technology, a set of security rules is stored. The set of security rules includes a set of reference signals. Telemetry data is received over time from an external device. A determination is made, based on the received telemetry data, as to whether the set of security rules has been violated. The determination includes behavioral pattern matching between the received telemetry data and at least one reference signal of the set of reference signals. The received telemetry data is selectively authorized as valid based on the determination.

Some examples of the disclosure include a system to monitor, detect and mitigate security threats to IoT devices, including security threats caused by invalid data, using telemetry data. In some examples, telemetry data from multiple IoT devices in the environment is used. In some examples, various security threats such as spoofed data, other intentionally invalid data, or data from defective devices are detected.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a system for IoT security;

FIG. 4 is a diagram illustrating an example dataflow for a process for IoT security; and

FIG. 5 is a logical flow diagram illustrating an example of a process for IoT security, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “IoT hub” is not limited to one particular type of IoT service, but refers to the device to which the IoT device communicates, after provisioning, for at least one IoT solution or IoT service of any type. That is, the term “IoT hub,” as used throughout the specification and the claims, is generic to any IoT solution.

Briefly stated, the disclosed technology is generally directed to device security in an IoT environment. In one example of the technology, a set of security rules is stored. The set of security rules includes a set of reference signals. Telemetry data is received over time from an external device. A determination is made, based on the received telemetry data, as to whether the set of security rules has been violated. The determination includes behavioral pattern matching between the received telemetry data and at least one reference signal of the set of reference signals. The received telemetry data is selectively authorized as valid based on the determination.

In some applications, IoT devices may be used to detect environmental and/or telemetry data for various reasons. It may be possible to spoof the environmental and/or telemetry data in various ways, or invalid data may result from defective devices. Some examples of the disclosure detect various security threats, including determining whether environmental and/or telemetry data is valid.

Some examples of the disclosure include a system to monitor, detect, and/or mitigate security threats to IoT devices, using telemetry data, and using other environmental data from other IoT devices.

In some examples, multiple agents on various IoT devices can be used to collect various types of data which can then be used conjunctively to form a more holistic model of device operation, and intrusion. In some examples, agent data from a collection of devices is used to form a model of the operating environment. In some examples, telemetry data from multiple IoT devices in the environment is used and a model of the environment is formed.

In some examples, the resulting model is used to detect security threats such as intrusions, invalid data, and/or tampering.

In some examples, an IoT device observes signals from one or more external devices that act as beacons, for example in industrial environmental safety applications, automotive applications, and/or the like. For example, an automobile may be and/or include an IoT device that observes, over time, signals from amulets configured to operate as beacons worn by pedestrians. The automobile may then indicate to the driver the presence of a pedestrian so that the driver of the automobile may avoid hitting the pedestrian. The driver may then act to avoid hitting the pedestrian even if doing so would result in swerving out to the way to hit a lamppost, for example. However, if there is not in fact a pedestrian present, the driver would not want to swerve out of the way to hit a lamppost. For example, an amulet may be left on the road unattended. Some examples of the disclosure detect the validity of certain telemetry data—for instance, in this example, whether the signal represents an actual pedestrian or not. In one example, the determination is made based on whether data received over time, including the spatial trajectory of a signal from a beacon over time, plausibly represents the behavior of a pedestrian or not.

### Illustrative Devices/Operating Environments

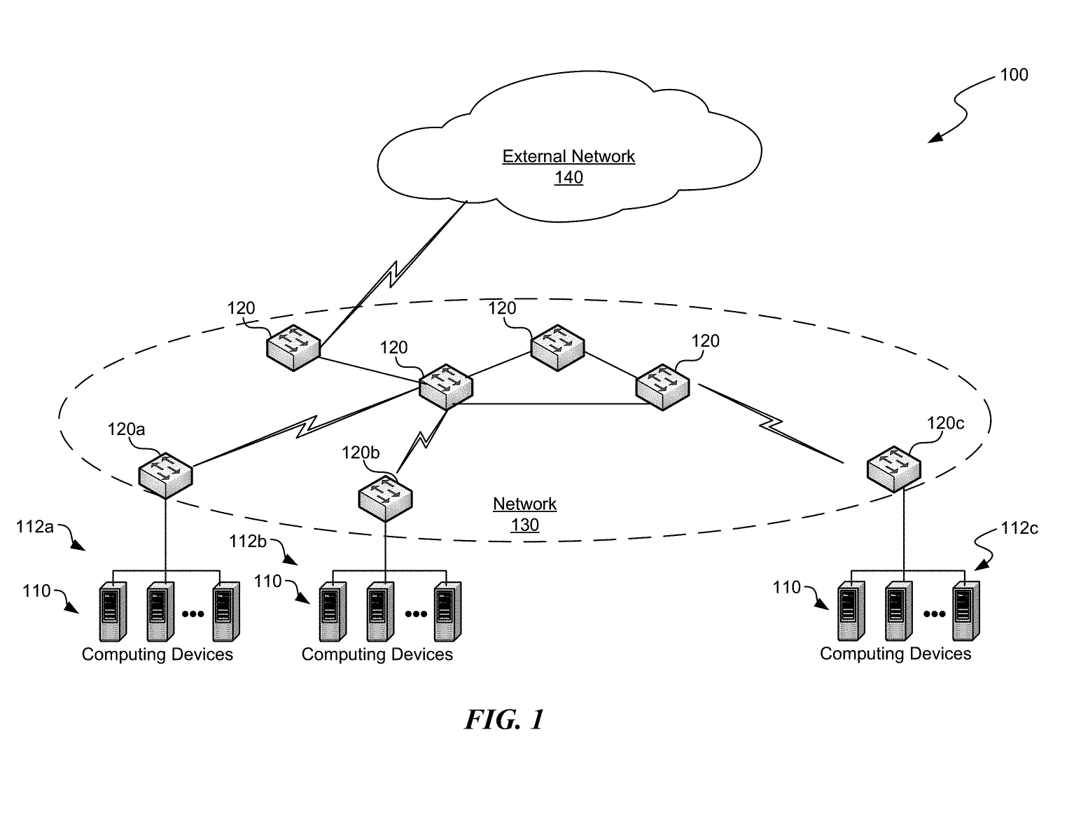

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices no may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is an IoT device, a gateway device, a device that comprises part or all of an IoT hub, a device comprising part or all of a device portal service, or the like, as discussed in greater detail below.

### Illustrative Computing Device

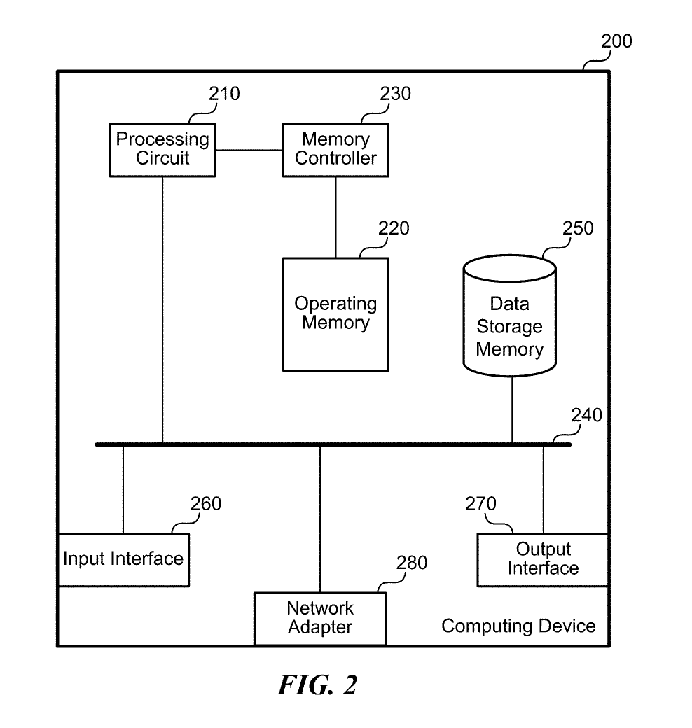

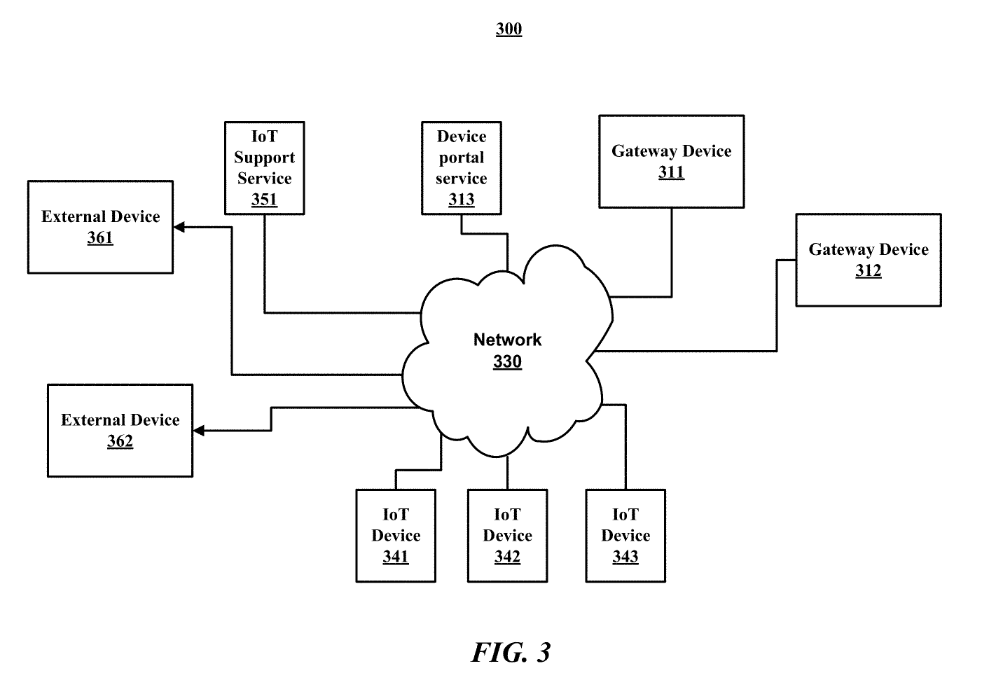

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be server device such as an application server computer, a virtual computing host computer, or a file server computer, e.g., computing device 200 may be an example of computing device 110 or network node 120 of FIG. 1. Computing device 200 may also be an IoT device that connects to a network to receive IoT services. Likewise, computer device 200 may be an example any of the devices illustrated in or referred to in FIGS. 3-5, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4th generation double data rate (DDR4) memory, 3rd generation double data rate (DDR3) memory, other dynamic random access memory (DRAM), High Bandwidth Memory (HBM), Hybrid Memory Cube memory, 3D-stacked memory, static random access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long Term Evolution (LTE) adapter, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

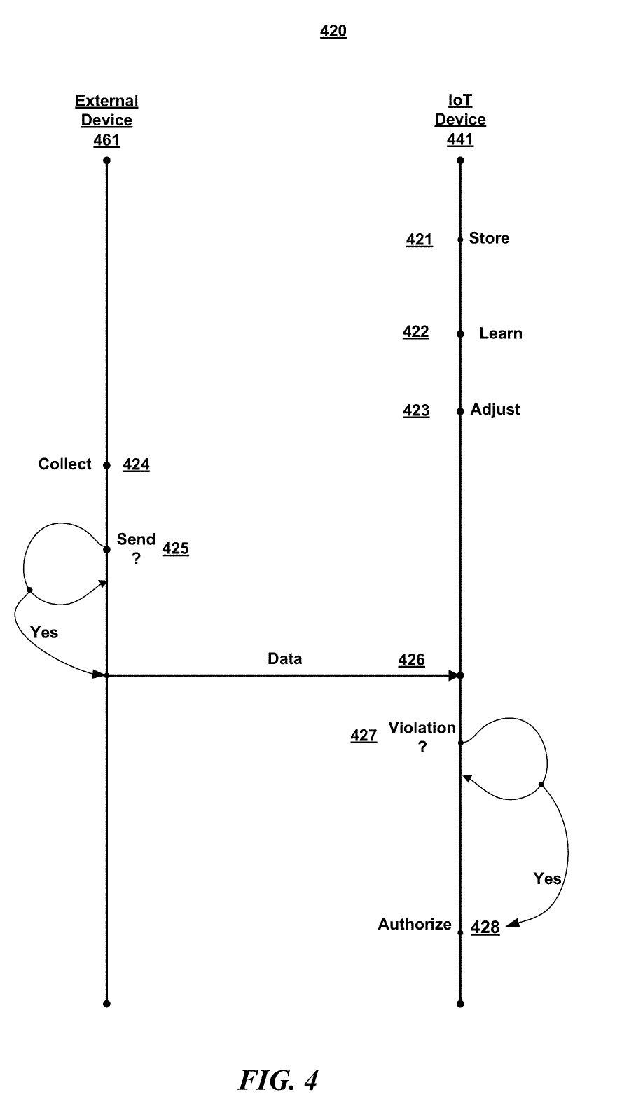

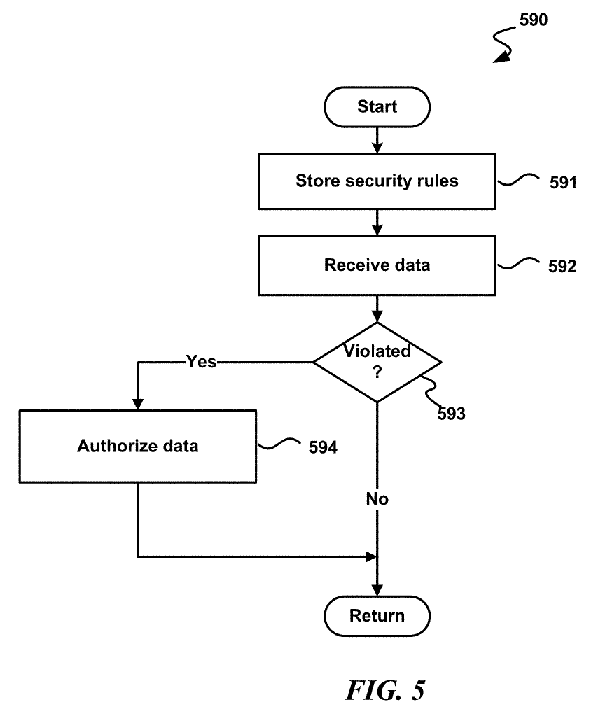

Some examples of computing device 200 include at least one memory (e.g., operating memory 220) adapted to store run-time data and at least one processor (e.g., processing unit 210) that is respectively adapted to execute processor-executable code that, in response to execution, enables computing device 200 to perform actions. In some examples, computing device 200 is enabled to perform actions such as the actions in the process of FIG. 4 or FIG. 5 below, or actions in a process performed by one or more of the computing devices in FIG. 3 below.

### Illustrative System

FIG. 3 is a block diagram illustrating an example of a system (300) for IoT security. System 300 may include network 330, IoT support service 351, IoT devices 341-343, gateway devices 311 and 312, external devices 361 and 362, and device portal service 313, which all connect to network 330.

In some examples, contrary to what is literally shown in FIG. 3, some or all of the communication is performed by non-network means. For instance, in some examples, beacons 311 and 312 are radio beacons that provide electromagnetic signals received through the air by various devices including, for example, active device 341 and corroborating device 361 and/or 362.

The term “IoT device” refers to a device intended to make use of IoT services. An IoT device can include virtually any device that connects to a network to use IoT services, including for telemetry collection or any other purpose. IoT devices include any devices that can connect to a network to make use of IoT services. In various examples, IoT devices may communicate with a cloud, with peers or local system or a combination or peers and local systems and the cloud, or in any other suitable manner. IoT devices can include everyday objects such as toasters, coffee machines, thermostat systems, washers, dryers, lamps, automobiles, and the like. IoT devices may also include, for example, a variety of devices in a “smart” building including lights, temperature sensors, humidity sensors, occupancy sensors, and the like. The IoT services for the IoT devices can be used for device automation, data capture, providing alerts, personalization of settings, and numerous other applications.

The term “IoT support service” refers to a device, a portion of at least one device, or multiple devices such as a distributed system, to which, in some examples, IoT devices connect on the network for IoT services. In some examples, the IoT support service is an IoT hub. In some examples, the IoT hub is excluded, and IoT devices communicate with an application back-end, directly or through one or more intermediaries, without including an IoT hub, and a software component in the application back-end operates as the IoT support service. IoT devices may receive IoT services via communication with the IoT support service. In some examples, an IoT support service may be embedded inside of a device, or in local infrastructure.

Each of the IoT devices 341-343, gateway devices 311 and 312, and/or the devices that comprise IoT support service 351 and/or device portal service 313 may include examples of computing device 200 of FIG. 2. The term “IoT support service” is not limited to one particular type of IoT service, but refers to the device to which the IoT device communicates, after provisioning, for at least one IoT solution or IoT service. That is, the term “IoT support service,” as used throughout the specification and the claims, is generic to any IoT solution. The term IoT support service simply refers to the portion of the IoT solution/IoT service to which provisioned IoT devices communicate. In some examples, communication between IoT devices and one or more application back-ends occur with an IoT support service as an intermediary. FIG. 3 and the corresponding description of FIG. 3 in the specification illustrates an example system for illustrative purposes that does not limit the scope of the disclosure.

External devices 361 and 362 may each be any suitable device that provides telemetry data, environmental data, and/or that like. In some examples, external device 361 is an IoT device. In some examples, external device 361 is an amulet or the like that operates as a beacon that provides data, such as a signal as a digital accelerometer reading, other suitable provided signal over time, or the like. Some examples of external device 361 are IoT devices with a particular registered identity, and other examples of external device 361 are “nomadic” devices that lack a registered identity. In some examples, external device 361 may be any suitable device that provides telemetry and/or environmental data that may be used by one or more of the IoT devices 341-343 while performing various functions.

Network 330 may include one or more computer networks, including wired and/or wireless networks, where each network maybe, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 330 includes any communication method by which information may travel between IoT support service 351, IoT devices 341-343, gateway devices 311-312, and device portal service 313.

As one example, IoT devices 341-343 are devices that are intended to make use of IoT services provided by the IoT support service, which, in some examples, includes one or more IoT support services, such as IoT support service 351. Device portal service 313 includes a device or multiple devices that perform actions in providing a device portal to users of IoT devices.

Optional gateway devices 311 and 312 are devices that may be used by some of the IoT devices 341-343 for accessing IoT support service 351. In some examples, after provisioning, some or all of the IoT devices 341-343 communicate to IoT support service 351 without using an intermediary. In other examples, some or all of the IoT devices 341-343 communicate with IoT support service 351 using an intermediary device such as one or more of gateway devices 311 and 312. Device portal service 313 is a service which may be used by users of IoT devices to manage IoT services for IoT devices including IoT devices 341-343.

System 300 may include more or less devices than illustrated in FIG. 3, which is shown by way of example only.

### Illustrative Processes

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as processor-readable instructions stored in a processor-readable storage medium or be performed as a computer-implemented process. As an alternate example, these processes may be encoded as processor-executable instructions and transmitted via a communications medium.

FIG. 4 is a diagram illustrating an example dataflow for a process (420) for IoT security. FIG. 4 and the corresponding description of FIG. 4 in the specification illustrate an example process for illustrative purposes that do not limit the scope of the disclosure.

In the illustrated example, first, step 421 occurs. At step 421, IoT device 441 stores a set of security rules. In some examples, the set of security rules includes a set of reference signals. In some examples, the set of security rules is based upon an assessment of telemetry data associated with at least one IoT device (e.g., external device 461). The set of security rules stored may differ, for example, based on the type of IoT device, upon the particular deployment context, and other factors.

The set of security rules may include reference signals where some or all of the reference signals are based upon at least one reference spatial trajectory over time. The reference signals may be based on reference “signal prints,” where the signal prints correspond to reference behaviors of signals over time. In one example, one reference signal is based on the spatial trajectory over time. In another example, one reference signal is based on temperature behavior over time. In some examples, the reference signal prints are configured for behavioral pattern matching to determine the plausibility of corresponding signals. For example, a reference signal print for a pedestrian may be configured for behavioral pattern matching to determine whether it is plausible that corresponding signals that are represented to be signals of the spatial trajectory of a pedestrian are in fact signals from a pedestrian. One or more or the reference signal prints may operate together as a reference model.

In some examples, the set of security rules includes one or both of a whitelist of processes and a blacklist of processes. The whitelist and blacklist of processes may be useful in determining whether or not an IoT device has been infected by malware. A “whitelist” of process refers to a list of approved processes, and a “blacklist” of processes refers to a list of processes designated as disallowed processes.

As shown, step 422 occurs next in some examples. In step 422, IoT device 441 may use machine learning with regard to the reference signals in the set of security rules. As previously discussed, in some examples, some or all of the reference signal prints are configured for behavioral pattern matching to determine the plausibility of corresponding signals. The accuracy of the reference signal prints may be improved based on machine learning at step 422. As shown, step 423 occurs next in some examples. At step 423, the set of security rules may be adjusted based on the machine learning performed at step 422 so that the reference signal prints are more accurately configured for behavioral pattern matching to determine of corresponding signals based on the machine learning performed at step 422. In some examples, the machine learning is based on a neural network model.

Although steps 422 and 423 are shown as performed by IoT device 441 in FIG. 4, in some examples, steps 422 and 423 are performed in one or more devices other than IoT device 441, and the adjusted set of security rules are provided to IoT device 441. In some examples, the initial security rules stored by IoT device 441 may already be adjusted based on machine learning.

As shown, step 424 occurs next in some examples. At step 424, external device 461 receives and/or collects environmental data from the environment. The environmental data may include telemetry data and/or the like. The telemetry data may include temperature, humidity, occupancy of a location associated with the IoT device, geolocation, and/or the like. The data may be collected via software inputs, hardware inputs, or both.

The telemetry data collected at step 424 may include telemetry that the IoT device already collects in some examples. For example, an IoT device that is a temperature sensor may already be configured to collect temperature data.

External device 461 may have one or more tampering switches that detect physical tampering. In one example, the tampering switch is off if external device 461 has not been physically tampered with, and the tampering switch is on if external device 461 has been physically tampered with. The environmental data may include an indication as to whether the tampering switch is on or off. For instance, in some examples, external device 461 has a cover that is connected to two tampering switches. If the cover is opened, both tampering switches turn on.

In some examples, external device 461 may include a software agent that collects the environmental data. In some examples, external device 461 has a software data collection agent deployed on external device 461 to collect environmental data. In some examples, some or all of the IoT devices have a software data collection agent deployed on the IoT device to collect environmental and/or internal state data from the IoT devices.

In some examples, the set of security rules stored in IoT device 441 is based on a model of the normal behavior of the IoT devices and/or the external devices. This model may represent the state of the IoT devices and/or external devices while these devices are working under normal conditions. In some examples, the set of security rules acts as a configurable IoT device model. The set of rules may be defined such that the set of rules is violated if an attack or other security intrusion or security threat occurs.

For example, the IoT devices may be subject to various types of security attacks which may be classified into several categories, including cyber attacks, physical attacks, and invalid data. Cyber-attacks include attacks on the cyber properties of the devices, such as on the operating system, network infrastructure, connection, and data. Physical attacks include attacks such as physical tampering of the devices, manipulation of data generation elements of the devices, relocation, and the like. In some examples, the set of security rules is generated or adjusted such that violation of the set of security rules indicates at least a possibility of an attack on one or more IoT devices. Accordingly, once any of these attacks occur, a violation of the set of rules should occur in one example since the data collected from the devices will then be contrary to the model. The model may include one or more patterns for the telemetry data.

Accordingly, the set of security rules may define normal operating conditions which, if not met, may indicate the possibility of a security threat. For example, the set of security rules may be violated if one or more of the data elements is outside of an expected range. For example, the set of security rules may require that temperature is in a certain range, that the tampering switch is off, that certain blacklisted processes are not running, and/or the like. Expected ranges or expected discrete values may be contingent upon time of day and other factors. In some examples, rather than simply comparing each type of data such as temperature or the like to an expected range (or expected discrete value) individually, the set of security rules are based on multiple types of data considered together, based on a model. For instance, in some examples, temperature in the environment above the expected range might not result in a violation of the security rules unless there is also occupancy in the environment.

In some examples, the set of security rules are based on a model of the environmental data collected by the IoT devices, where the model effectively provides a “golden” image of the expected data. The golden image may reflect normal behavior of the IoT devices in normal operating conditions absent any intrusion or security threat. If, based on the received IoT data, some aspects differ from the golden image, the set of rules might be considered to be violated depending on other data. For instance, accordingly to the golden image for an occupancy sensor of a particular room in the mall, the occupancy sensor should not show occupancy during certain hours in which no one is expected to be present in the mall. However, the rules may specify that, for example, if the mall gate is open and the guard is still present in the mall, then the occupancy at the unexpected time does not trigger a violation of the set of security rules. In some examples, data from multiple IoT devices may be involved in the model and set of security rules in order to determine whether or not the set of rules have been violated. By using data from multiple IoT devices, a more holistic model of device operation and operating environment and intrusion may be used than if the model were based upon one IoT device.

In some examples, the collected IoT data, including collected telemetry data, can be used to assist in constructing the model in order to create or adjust the set of security rules.

In some examples, external device 461 operates as a beacon that provides a signal over time. In some examples, the beacon provides a signal that can be tracked by other devices over time to determine spatial trajectory or the like. Other examples, the beacon provides accelerometers readings or the like.

As shown, step 425 occurs next in some examples. At step 425, external device 461 may make a determination as to whether or not to send data to IoT device 441. In some examples, at step 425, external device 461 simply determines to always send all of the data to IoT device 441. In some examples, data is only sent upon a threshold based on one of more of the types of data being exceeded.

For instance, in some examples, external device 461 makes a determination to send temperature data only if the temperature detected is outside of a predetermined range, such as 65-75 degrees Fahrenheit. In some examples, the fact that the temperature is outside of the range of 65-75 degrees Fahrenheit is not in and of itself a violation of the security rules—external device 461 does not make the determination about whether or not the set of security rules are violated, in this example, but only sends temperature data upon temperature being outside of a particular range, and for which therefore there might be a violation of the set of security rules depending on other factors.

As shown, step 426 occurs next in some examples when the determination at step 425 is positive. At step 426, the IoT data may be communicated from external device 461 to IoT device 441. If, in contrast, the determination at step 426 is negative, other processing is resumed.

As shown, step 427 occurs next after step 426 in some examples. At step 427, IoT device 441 may make a determination, based on the IoT data received at step 426, as to whether the set of security rules stored in IoT device 441 has been violated. In some examples, the determination at step 427 may be a comparison of the aggregated IoT device data with the configurable IoT device model.

In some examples, the determination at step 427 includes behavioral pattern matching between the received environmental/telemetry data received over time and at least one reference signal in the set of reference signals in the security rules. In some examples, the set of security rules, including the reference signal, act as a reference model, and at step 427, the received environmental data is compared with the reference model using behavioral pattern matching. In some examples, step 427 includes behavioral pattern matching between the received telemetry data and at least one corresponding reference signal print in the set of reference signal prints.

As one example, external device 461 may be an amulet operating as a beacon that is designed to be used in safety applications, such as to prevent a pedestrian or pet from being struck by an automobile. The reference signals may include spatial trajectories over time for pedestrians, and/or for certain pets such as dogs and cats. At step 427, IoT device 441 may use behavioral pattern matching, enhanced by machine learning, to determine whether the signal from external device 461, based on the trajectory of the signal over time, plausibly belongs to, for example, a pedestrian, a dog, or a cat, based on observed behavior.

As another example, a temperature sensor, which is used, among other things, to detect fires, may provide temperature data, which is compared with reference signal to determine whether the provided temperature data is plausible. For example, if a match is placed directly under a temperature sensor, the resulting rise in temperature can be determined as implausible at step 427, so that there is no false detection of a fire. Similarly, if the temperature is detected to be exactly 80.0 degrees over a long period of time, with no variation at all, this may be detected as implausible because temperature would normally vary by slight amounts over time, such as being 80.0 degrees at one moment and 80.1 degrees at another.

As another example, external device 461 may be a beacon used in industrial environment safety applications, such as factory floor workplace safety, or any environment with nomadic devices. The nomadic devices may be beacons, or the like. The presence of a particular type of device in the environment can be detected and determined based on behavioral pattern matching with reference signals, for example based on motion behavior detected.

As another example, a car may be equipped with an “electronic braking light” that emits a radio signal about the car's deceleration to following cars. Accordingly, each car so equipped is an external device operating as a beacon. The following cars' driver assistance and active safety systems can be equipped as IoT devices and learn about acceleration and deceleration of vehicles ahead of them including those not immediately in line of sight. If a car A follows another car B, and car B suddenly changes out of the lane to evade a sharply braking car C in its lane ahead, car A can anticipate car C's presence and its braking action despite the line of sight (visual and radar) being blocked by car B until it has cleared the lane. Car A's active safety system can therefore either also decide to evade car C or initiate an appropriate braking action.

At decision block 427 of this scenario, the security question is whether the radio signal from car C can be trusted. If it is possible to make car A indicate incorrectly that there is a vehicle braking sharply ahead beyond its line of sight, the vehicle might initiate an emergency maneuver that puts the passengers and other traffic participants at risk.

The determination at decision block 427 in this scenario is based upon the concrete behavior of the car on the street and establishing the fact that the car is plausibly behaving as it indicated by its signal. The determination at decision block 427 is, among other things, based upon trust that car C is present in the real world.

There are many potential attacks against car A in this scenario. What is important that sensor defects or other software defects may be as much of factor here are malice.

As one example, Car C may emit a signal, but fail to report its deceleration correctly. Car B has line of sight and can override that reading with its onboard sensors. Car A's will stay on its trajectory trusting the emitted signal and rear-end Car C.

As another example, Car C may emit a signal indicating an emergency-style deceleration while that is factually not the case and therefore false force cars B and C into emergency evasion maneuvers that may put them and other traffic participants at risk.

As yet another example, Car C may not exist. The signal may be emitted by a forged device or by an original, legitimate signal emitter that has been removed from another vehicle and that is introduced into the traffic situation by some means, including in another car or from a bridge or from the side of the street.

As still another example, Car C exists, but its radio signal is captured elsewhere and replayed into the current situation, e.g., using an analog signal amplifier.

At decision block 427, in this scenario, a determination is made based on trust that Car C gains with Car A and Car B through its behavior in the environment and not through its identity.

The behavior matching may be used to detect implausibility both for the purpose of detecting intentional spoofs and other similar attacks, as well as detecting defective devices that are giving false readings. In some examples, a plausibility score may be generated based on comparing the received telemetry with the reference model, and the determination at step 427 is positive if the plausibility score exceeds a particular threshold.

In some examples, in addition to a plausibility evaluation, the determination at step 427 further includes corroboration among multiple devices. For example, sensor fusion may be used as part of the determination at step 427, as discussed in further detail below. Behavioral pattern matching alone may not detect a spoofed signal in a hacked device if the spoofed data is plausible. By receiving telemetry from multiple devices, however, it may be determined that the signal is spoofed unless all of the devices reading the data are hacked. The greater the number of independent devices corroborate on a behavioral observation, the more trust can be established on the behavioral observation.

In some examples, the determination at step 427 is identity-agnostic, and in other examples, the determination at step 427 is dependent on identity and the security rules including behavior matching strengthen the identify determination.

For example, in the case of an amulet worn by a pedestrian in which the signal is used so that driver of automobiles may avoid hitting pedestrians, the identity of the amulet is irrelevant. The relevant determination is whether or not the signal is originates from an actual pedestrian or not—the identity of the pedestrian or identity of the pedestrian's device is irrelevant. In the case of a temperature sensor installed in a smart building, however, the identity of the device should be verified in order for the data provided to be trusted, since a device lacking the expected identity is generally a strong indicator for likely untrustworthy information in such a setting.

As shown, step 428 occurs next in some examples. At step 428, IoT device 441 selectively authorizes the received telemetry/environmental data based on the determination at step 427. If at step 427 it was determined that the set of rules were violated, IoT device 441 authorizes the received telemetry data. If instead at step 427 it was determined that the set of rules were not violated, IoT device 441 does not authorize the received telemetry data.

If external device 461 becomes disconnected from the cloud, data cannot be collected from external device 461, but the fact that external device 461 is disconnected from the cloud is itself a form of information and in some examples the disconnection may result in a security violation, depending on the context.

In some examples, the set of security rules may be further adjusted over time, both to reduce false positives, and to successfully detect attacks that might otherwise not be detected. In some examples, IoT device 441 includes yet an additional learning layer that learns from anomalies and adapts by changing the set of security rules over time and learning over time.

In some examples, at step 428, rather than simply invalidating the data, other details, including, for example, information about the nature of the attack or threat or invalid data, as far as can be determined, is also determined. Aggregate data from multiple IoT devices can also be used, when applicable, to further describe the nature of the security threat.

In some examples, detective devices may be detected by process 420, and such defective devices may be blacklisted so that data from defective devices are not used in the future.

In some examples, a configuration request may be communicated to IoT device 441. The configuration request may be associated with adjusting the set of security rules stored in IoT device 441. In some examples, the configuration request is a request to change a set of security rules to an adjusted set of security rules. The configuration request can be made in different ways in different examples. In some examples, there is a basic mode in which the default set of security rules is used, and there is also an advanced setting where the user can make a configuration request to change default set of security rules. IoT device 441 may adjust the set of security rules stored in IoT device 441 based on the received configuration request.

FIG. 5 is a logical flow diagram illustrating an example of a process (590) for IoT authentication. In one example, process 590 is performed by an IoT device, such as IoT device 341 of FIG. 1. After a start block, the process proceeds to block 591. At block 591, a set of security rules is stored. The set of security rules include a set of reference signals. The process then moves to block 592. At block 592, telemetry data is received over time from an external device. The process then proceeds to decision block 593.

At decision block 593, a determination is made, based on the received telemetry data, as to whether the set of security rules has been violated. If the determination at decision block 593 is negative, the process proceeds a return block, where other processing is resumed. If, instead the determination at decision block 593 is positive, the process advances to block 594, where the received telemetry data is authorized as valid based on the determination. The process then proceeds to a return block, where other processing is resumed. In this way, the received telemetry data is selectively authorized as valid based on the determination.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus for Internet of Things (IoT) security, comprising:
a device including at least one memory adapted to store run-time data for the devices, and at least one processor that is adapted to execute processor-executable code that, in response to execution, enables the device to perform actions, including:
storing a set of security rules, wherein the set of security rules include a set of reference signals;
receiving telemetry data over time from an external device;
making a determination, based on the received telemetry data, as to whether the set of security rules has been violated, wherein the determination includes behavioral pattern matching between the received telemetry data and at least one reference signal of the set of reference signals; and
selectively authorizing the received telemetry data as valid based on the determination.

2. The apparatus of claim 1, the actions further including:
receiving a configuration request; and
adjusting the set of security rules based on the configuration request.

3. The apparatus of claim 1, wherein the received telemetry data includes data from a plurality of external devices including the external device, and wherein making the determination is further based on determining corroboration of the received telemetry data among the plurality of external devices.

4. The apparatus of claim 1, wherein the behavioral pattern matching is based upon machine learning.

5. The apparatus of claim 1, wherein the set of security rules includes at least one of a whitelist of processes and a blacklist of processes.

6. The apparatus of claim 1, wherein at least one of the reference signal is based upon at least one reference spatial trajectory over time, and wherein the determination is made based on a comparison of a spatial trajectory over time associated with the received telemetry data with the at least one reference spatial trajectory over time.

7. The apparatus of claim 1, wherein the received telemetry data is aggregated from multiple devices including at least the external device.

8. The apparatus of claim 1, wherein the determination is based on a determined plausibility of the received telemetry data, wherein the plausibility is determined based on a comparison with at least one reference signal in the set of reference signals.

9. The apparatus of claim 1, wherein the received telemetry data includes at least one of temperature, humidity, sensed location, or geolocation.

10. The apparatus of claim 1, wherein the set of security rules are such that violation of the set of security rules indicates at least a possibility of an attack, wherein the attack is at least at least one of a physical attack or a cyber attack on the at least one IoT device.

11. The apparatus of claim 1, wherein the external device is at least one of a beacon or an IoT device.

12. A method for Internet of Things (IoT) security, comprising:
generating a reference model based on machine learning;
receiving environmental data over time from an external device;
employing at least one processor to compare the received environmental data with the reference model using behavioral pattern matching; and
selectively authorizing the received environmental data as valid based on the comparison.

13. The method of claim 12, wherein the received telemetry data includes data from a plurality of external devices including the external device, and wherein employing the at least one processor to compare the received environmental data with the reference model using behavior pattern matching further includes determining corroboration of the received telemetry data among the plurality of external devices.

14. The method of claim 12, wherein at least one of the reference signal is based upon at least one reference spatial trajectory over time, and employing the at least one processor to compare the received environmental data with the reference model using behavior pattern matching further includes comparing a spatial trajectory over time associated with the received environmental data with the at least one reference spatial trajectory over time.

15. The method of claim 12, wherein employing the at least one processor to compare the received environmental data with the reference model using behavior pattern matching further includes determining a plausibility of the received telemetry data, such the plausibility is determined based on a comparison with at least one reference signal in the set of reference signals.

16. The method of claim 12, wherein the external device is at least one of a beacon or an IoT device.

17. A processor-readable storage medium, having stored thereon processor-executable code, that, upon execution by at least one processor, enables actions, comprising:
storing a set of security rules, wherein the set of security rules include a set of reference signal prints, wherein the reference signal prints correspond to reference behaviors of signals over time based on machine learning such that the reference signal prints are configured for behavioral pattern matching to determine the plausibility of corresponding signals;
receiving telemetry data over time from an external device;
making a determination, based on the received telemetry data, as to whether the set of security rules has been violated, wherein the determination includes behavioral pattern matching between the received telemetry data and at least one corresponding reference signal print in the set of reference signal prints; and
selectively authorizing the received telemetry data as valid based on the determination.

18. The processor-readable storage medium of claim 17, wherein the received telemetry data includes data from a plurality of external devices including the external device, and wherein making the determination is further based on determining corroboration of the received telemetry data among the plurality of external devices.

19. The processor-readable storage medium of claim 17, wherein at least one of the reference signal is based upon at least one reference spatial trajectory over time, and wherein the determination is made based on a comparison of a spatial trajectory over time associated with the received telemetry data with the at least one reference spatial trajectory over time.

20. The processor-readable storage medium of claim 17, wherein the determination is based on a determined plausibility of the received telemetry data, wherein the plausibility is determined based on a comparison with at least one reference signal in the set of reference signals.
